(19) United States
(12) Patent Application Publication
(10) Pub. No.: US 2012/0256855 A1
(43) Pub. Date: Oct. 11, 2012

(54) DRIVING AND SENSING METHOD FOR TOUCH-SENSING INPUT DEVICE, AND MODULE USING THE SAME

(75) Inventors: CHIEN YU CHAN, Hsinchu City (TW); SHANG PING TANG, Hsinchu City (TW)

(73) Assignee: RAYDIUM SEMICONDUCTOR CORPORATION, HSINCHU (TW)

(21) Appl. No.: 13/429,784

(22) Filed: Mar. 26, 2012

(30) Foreign Application Priority Data
Apr. 8, 2011 (TW) 100112165

(51) Int. Cl. G06F 3/041

(52) U.S. Cl. 345/173

(57) ABSTRACT

The disclosure provides a driving and sensing method for a touch-sensing input device including a touch-sensing panel module and a liquid crystal display panel module. The touch-sensing panel module includes a touch-sensing panel and a control device, wherein the touch-sensing panel includes a plurality of X-directional lines and Y-directional lines arranged intersecting one another. The method includes steps of generating a spread spectrum clock signal using the control device; generating a driving signal and a sensing signal based on the spread spectrum clock signal; outputting the driving signal to one of the X-directional lines or one of the Y-directional lines; receiving voltages on the corresponding Y-directional line or X-directional line in response to the sensing signal and converting the same to a digital signal; and determining a touch status of the touch-sensing panel based on the digital signal.

### BACKGROUND

1. Technical Field

The present invention relates to a driving and sensing method for a touch-sensing input device, and a module using the same, wherein the touch-sensing input device includes a touch-sensing panel module and a liquid crystal display panel module.

2. Related Art

Recently, touch-sensing panels have been widely applied in the fields of home appliance products, communication devices, and electronic information devices, among others. Touch-sensing panels are usually applied as input interfaces of consumer electronics, such as personal digital assistants (PDA), game consoles, etc. The recent trend of integrating a touch-sensing panel with a liquid crystal display panel allows a user to use a finger or a stylus to select an icon displayed on the panel, and the PDA, electronic product or game console executes the indicated function. This type of touch-sensing panel may also be applied in a public information query system, allowing the public to operate the system more efficiently.

FIG. 1 is a schematic diagram illustrating a prior art touch-sensing input device 10. The input device 10 includes a liquid crystal display (LCD) panel 11, a gate driving circuit 12, a source driving circuit 13, a timing control circuit 14, a touch-sensing panel 15 and a touch-sensing panel control circuit 16. Referring to FIG. 1, the touch-sensing panel 15 is formed over the LCD panel 11. The timing control circuit 14 receives a horizontal synchronization signal HSYNC, a vertical synchronization signal VSYNC, a clock signal CLK and an image data signal RGB_DATA, and sends the image data signal RGB_DATA, a gate driving signal and a source driving signal to the source driving circuit 13 and the gate driving circuit 12. Upon receiving the image data signal RGB_DATA and the source driving signal, the source driving circuit 13 outputs the image data signal RGB_DATA to data lines of the LCD panel 11 in response to the horizontal synchronization signal HSYNC. Upon receiving the gate driving signal, the gate driving circuit 12 generates a gate line driving signal to sequentially drive gate lines of the LCD panel 11.

Referring to FIG. 1, the touch-sensing panel 15 includes a plurality of X-directional lines and a plurality of Y-directional lines. The touch-sensing panel control circuit 16 is configured to provide a driving signal for the X-directional line or Y-directional line, and receive induced voltage on the corresponding Y-directional line or X-directional line. The induced voltage is converted to a digital signal in the touch-sensing panel control circuit 16 and then filtered by a filter circuit to reduce noise. Subsequently, the control circuit 16 calculates a touch status of the touch-sensing panel using the filtered digital signal according to an algorithm. Because the value of the induced voltage changes based on how a user touches the lines, the control circuit 16 can obtain a touch status such as a touched position and a touched area, by performing calculation on the digital signal representing the induced voltage.

In the prior art technique, when the source driving circuit 13 outputs data to the data lines of the LCD panel 11, or when the gate driving circuit 12 drives the gate lines of the LCD panel 11, the touch-sensing panel 15 can easily sense the driving signals. Therefore, in the prior art configuration, the touch-sensing panel control circuit 16 needs to include a complicated filter circuit to filter out noise signals. In addition, the control circuit 16 requires an extra pin to receive a signal from the timing control circuit 14, so as to generate control signals for the touch-sensing panel 15 separate from the driving signals based on the signal. In order to eliminate the extra pin and simplify the filter circuit, there is a significant need to provide a driving and sensing method adapted for the touch-sensing input device and module using the same which solve the foregoing problems.

### SUMMARY

The present invention discloses a driving and sensing method for a touch-sensing input device. The touch-sensing input device includes a touch-sensing panel and a liquid crystal display panel. The liquid crystal display panel includes a touch-sensing panel and a control device, wherein the touch-sensing panel includes a plurality of first-directional lines and a plurality of second-directional lines, and the first-directional lines and the second-directional lines are arranged intersecting one another. The driving and sensing method includes the following steps: generating a spread spectrum clock signal using the control device; generating a driving signal and a sensing signal based on the spread spectrum clock signal; outputting the driving signal to one of the first-directional lines or one of the second-directional lines; receiving voltages on the corresponding second-directional line or first-directional line in response to the sensing signal and converting the same to a digital signal; and determining a touch status of the touch-sensing panel based on the digital signal.

The present invention also discloses a driving and sensing module of a touch-sensing input device. The touch-sensing input device includes a touch-sensing panel module and a liquid crystal display panel module. The touch-sensing panel module includes a touch-sensing panel and the driving and sensing module, wherein the touch-sensing panel comprises a plurality of first-directional lines and a plurality of second-directional lines, and the first-directional lines and the second-directional lines are arranged intersecting one another. The driving and sensing module includes a spread spectrum clock generator, a selection module, a driving signal generation circuit, an analog to digital conversion module and a signal processing unit. The spread spectrum clock generator is configured to generate a spread spectrum clock signal. The selection module is configured to select a scan line and a sense line of each scanning operation from the first-directional lines and the second-directional lines. The driving signal generation circuit is configured to generate a driving signal applied to the scan line selected during each scanning operation by the selection module based on the spread spectrum clock signal. The analog to digital conversion module is configured to receive voltages on the sense line selected during each scanning operation by the selection module based on the spread spectrum clock signal, and convert the voltages to a digital signal. The signal processing unit is configured to calculate a touch status of the touch-sensing panel based on the digital signal output from the analog to digital conversion module.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed might be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon reference to the accompanying drawings in which:

FIG. 1 is a schematic diagram illustrating a prior art touch-sensing input device;

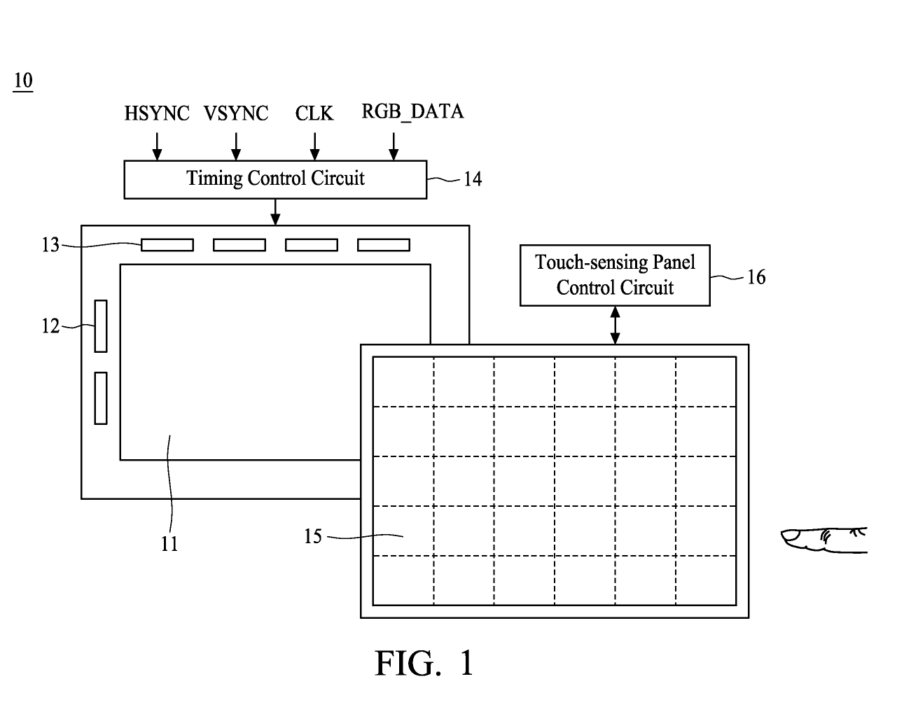

FIG. 2 is a schematic block diagram illustrating a touch-sensing input device according to an embodiment of the present invention;

FIG. 3 is a schematic block diagram illustrating a liquid crystal display panel module according to an embodiment of the present invention;

FIG. 4 is a schematic block diagram illustrating a touch-sensing panel module according to an embodiment of the present invention;

FIG. 5 is a flow chart illustrating a driving and sensing method according to an embodiment of the present invention;

FIG. 6 is a schematic block diagram illustrating a spread spectrum clock generator according to an embodiment of the present invention;

FIG. 7 is a schematic waveform diagram of the spread spectrum clock generator illustrated in FIG. 6;

FIG. 8A is a schematic block diagram of a digital spread spectrum clock generator according to an embodiment of the present invention;

FIG. 8B is a schematic waveform diagram of a digital spread spectrum clock generator according to an embodiment of the present invention; and

FIG. 9 is a schematic block diagram illustrating an analog to digital conversion module according to an embodiment of the present invention.

### DESCRIPTION OF THE EMBODIMENTS

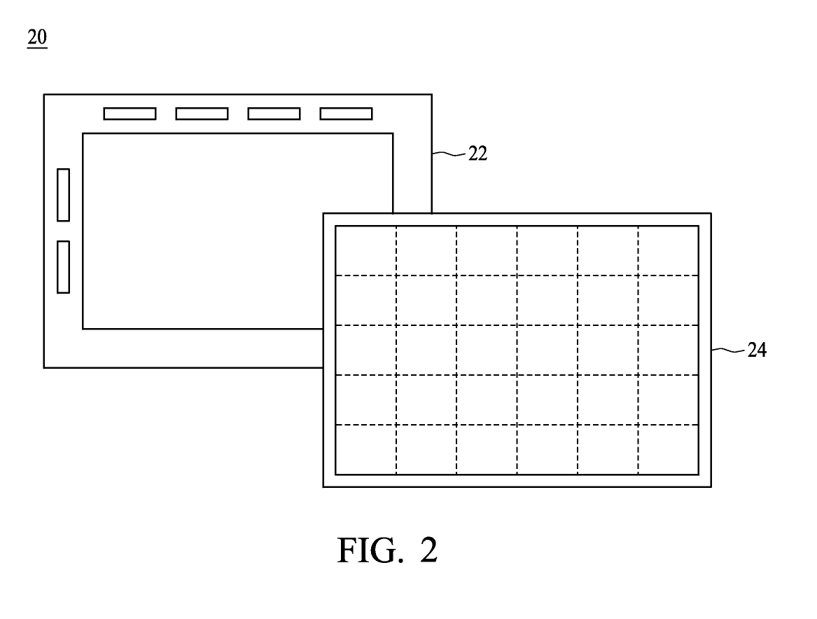

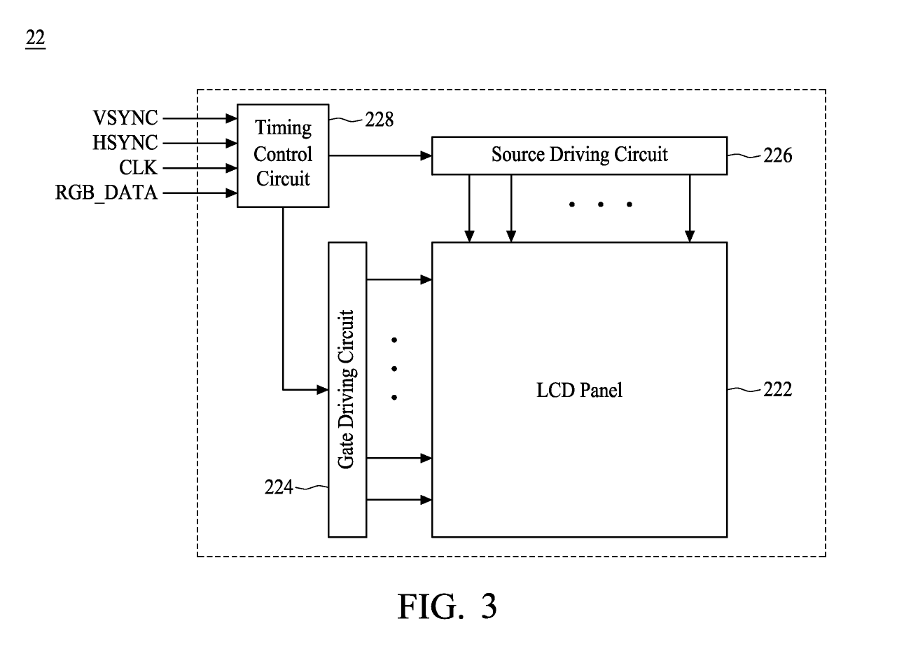

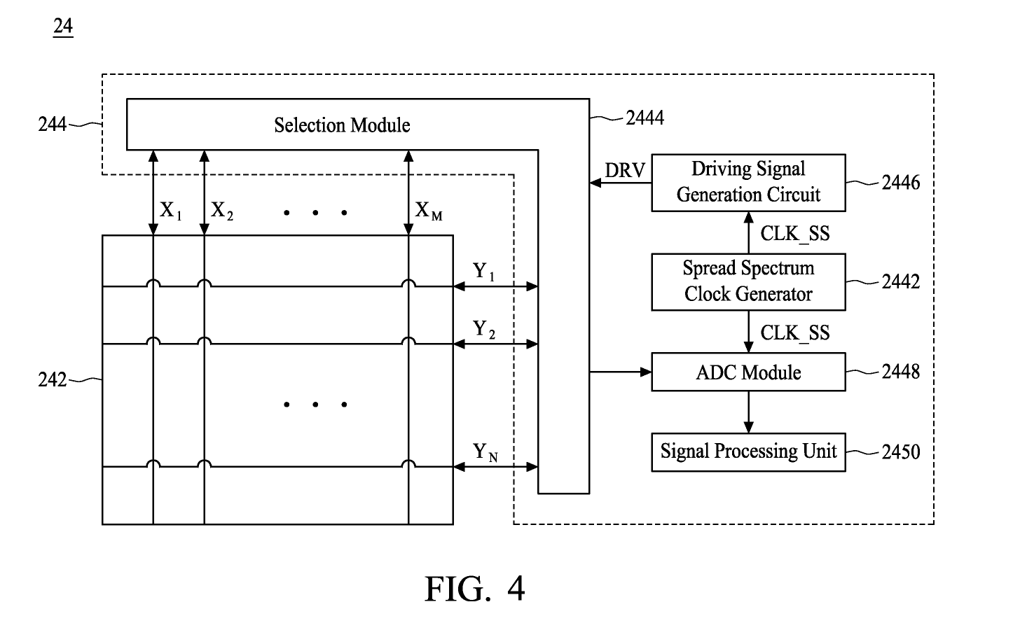

In order to more clearly describe a driving and sensing method for a touch-sensing input device according to the present invention, the touch-sensing input device is described first as follows. FIG. 2 illustrates a touch-sensing input device 20 according to an embodiment of the present invention. The touch-sensing input device 20 includes a liquid crystal display (LCD) panel module 22 and a touch-sensing panel module 24. The touch-sensing panel module 24 is formed over the LCD panel module 22. FIG. 3 is a schematic block diagram illustrating the LCD panel module 22. Referring to FIG. 3, the LCD panel module 22 includes an LCD panel 222, a gate driving circuit 224, a source driving circuit 226 and a timing control circuit 228. FIG. 4 is a schematic block diagram illustrating the touch-sensing panel module 24. Referring to FIG. 4, the touch-sensing panel module 24 includes a touch-sensing panel 242 and a touch-sensing panel control unit 244. The touch-sensing panel 242 includes a plurality of X-directional lines X₁ to X_{M} and a plurality of Y-directional lines Y₁ to Y_{N}. The touch-sensing panel control unit 244 includes a spread spectrum clock generator 2442, a selection module 2444, a driving signal generation circuit 2446, an analog to digital conversion (ADC) module 2448 and a signal processing unit 2450.

The X-directional lines X₁ to X_{M} and Y-directional lines Y₁ to Y_{N} illustrated in FIG. 4 are buried in different layers of the touch-sensing panel 242. Referring to FIG. 4, the X-directional lines X₁ to X_{M} and Y-directional lines Y₁ to Y_{N} are arranged intersecting one another to form a rectangular grid. In the rectangular grid, a mutual capacitor (not illustrated) is formed between each X-directional line and each Y-directional line. Through the coupling effect of the mutual capacitors, when a driving signal is applied to an X-directional line or a Y-directional line, a plurality of induced voltages are generated on the corresponding Y-directional line or X-directional line. Since the values of the induced voltages change depending on how a user touches the line, by detecting the induced voltages, a touched position of the user can be determined.

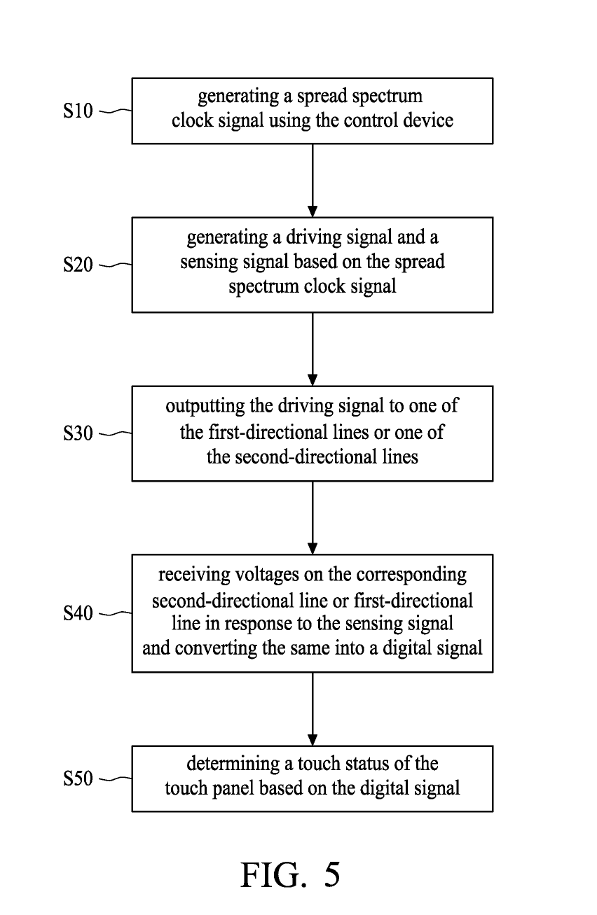

FIG. 5 is a flow chart illustrating a driving and sensing method according to an embodiment of the present invention which can be applied to the touch-sensing panel module 24 in the touch-sensing input device 20. The driving and sensing method includes the following steps: generating a spread spectrum clock signal using the control device (step S10); generating a driving signal and a sensing signal based on the spread spectrum clock signal (step S20); outputting the driving signal to one of the first-directional lines or one of the second-directional lines (step S30); receiving voltages on the corresponding second-directional line or first-directional line and converting the same to a digital signal (step S40); and determining a touch status of the touch-sensing panel based on the digital signal (step S50). In order to enable persons having ordinary skills in the art to implement the present invention based on the teaching of the present embodiment, details further describing the driving and sensing method of the present invention with reference made to the accompanying drawings are provided below.

Referring to FIG. 3, when the LCD panel module 22 is in operation, the timing control circuit 228 receives a horizontal synchronization signal HSYNC, a vertical synchronization signal VSYNC, a clock signal CLK and an image data signal RGB_DATA from a video processing system (not illustrated), and transmits the image data signal RGB_DATA, a source driving signal and a gate driving signal to the source driving circuit 226 and the gate driving circuit 224. After receiving the image data signal RGB_DATA and the source driving signal, the source driving circuit 226 outputs the image data signal RGB_DATA to data lines of the LCD panel 11 in response to the horizontal synchronization signal HSYNC. The gate driving circuit 224 includes a plurality of gate lines. After receiving the gate driving signal, the gate driving circuit 224 controls the gate lines such that the signal from the source driving circuit 226 is transmitted to the LCD panel 222 in sequence.

Since the touch-sensing panel module 24 covers the top of the LCD panel module 22, when the LCD panel module 22 is in operation, particularly when the source driving circuit 226 is generating the data line driving signal or when the gate driving circuit 224 is generating the gate line driving signal, the touch-sensing panel module 24 may easily couple the driving signals. Therefore, when the touch-sensing panel module 24 is detecting the touch status of the touch-sensing panel 242, it is preferable to keep the detecting period separate from the generation period of the driving signals to prevent the noise coupling effect. Accordingly, the prior art touch-sensing panel module requires an extra pin to receive the horizontal synchronization signal of the timing control circuit to generate control signals based on the horizontal synchronization signal. The control signals of the touch-sensing panel will have a large enough remaining period to avoid the generation period of the driving signals.

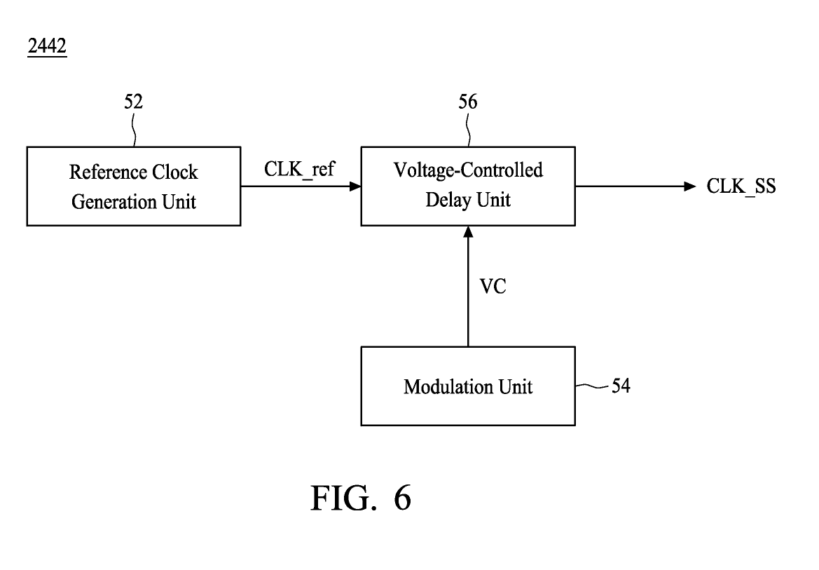

However, in the present invention, the touch-sensing panel module 24 avoids the generation period of the driving signals based on the internally generated spread spectrum clock signal. FIG. 6 is a schematic block diagram illustrating a spread spectrum clock generator 2442 according to an embodiment of the present invention. The spread spectrum clock generator 2442 includes a reference clock generation unit 52, a modulation unit 54 and a voltage-controlled delay unit 56. Referring to FIG. 6, the reference clock generation unit 52 is configured to generate a reference clock signal CLK_ref having a fixed frequency. The modulation unit 54 is configured to generate a voltage control signal VC. The voltage-controlled delay unit 56 is coupled between the reference clock generation unit 52 and modulation unit 54, and is configured to perform frequency modulation on the reference clock signal CLK_ref based on the voltage control signal VC, whereby the spread spectrum clock signal CLK_SS is generated.

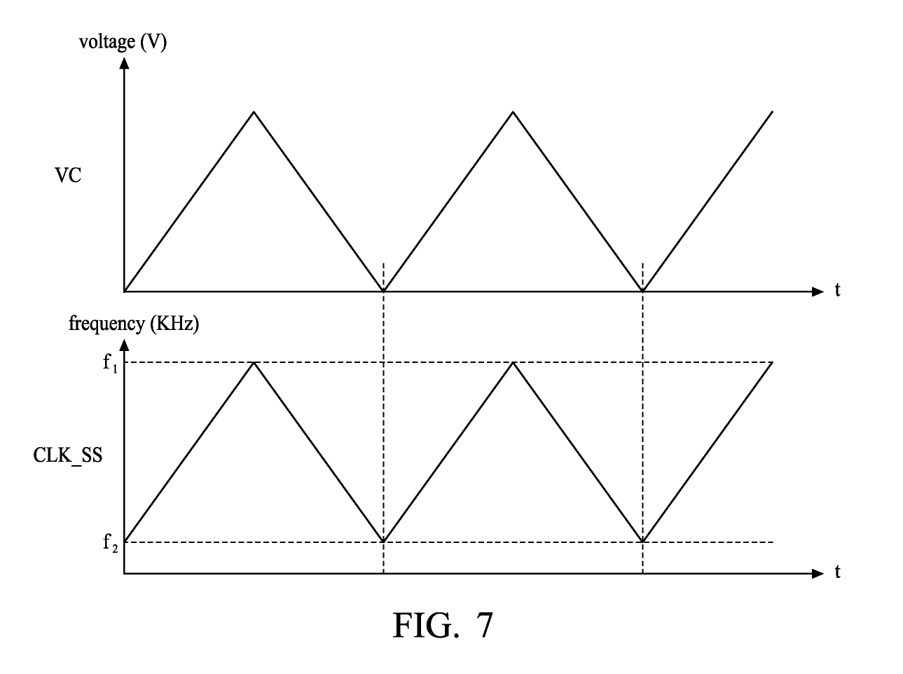

The voltage-controlled delay unit 56 may be a digital delay circuit or an analog delay circuit. In the present embodiment, the voltage-controlled delay unit 56 is an analog delay circuit which performs frequency modulation on the reference clock signal CLK_ref based on the voltage control signal VC, so that the spread spectrum clock signal CLK_SS varies periodically. For example, as illustrated in FIG. 7, the voltage control signal VC is a triangular wave signal, and the frequency of the spread spectrum clock signal CLK_SS after modulation alternates between frequencies f₁ and f₂ in the form of triangular waves. In other embodiments, the control signal can be a sine wave signal or a Hershey's Kiss signal. Moreover, a pulse width of the spread spectrum clock signal CLK_SS can be adjusted based on another output signal of the modulation unit 54.

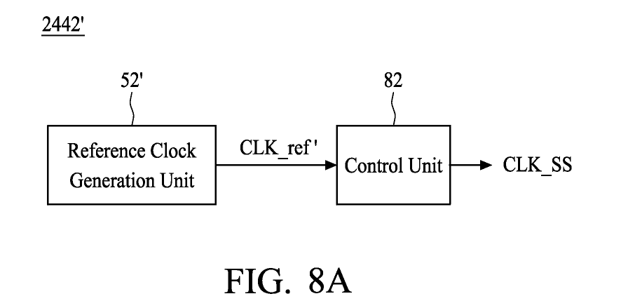

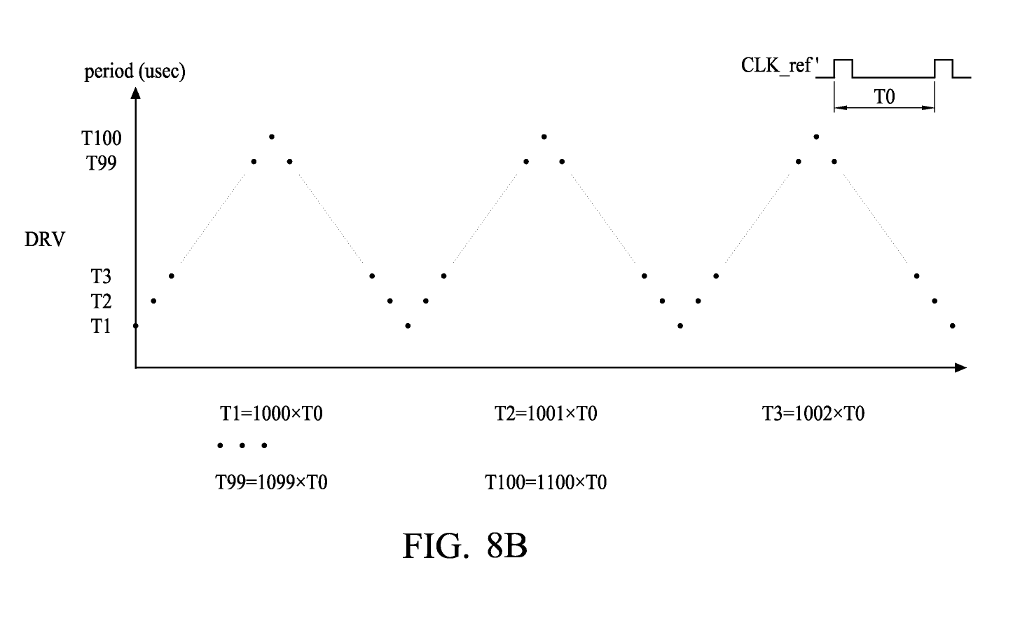

In the foregoing embodiment, the spread spectrum clock generator 2442 is implemented in an analog manner However, the spread spectrum clock generator may also be implemented in a digital manner FIG. 8A is a schematic block diagram illustrating a digital spread spectrum clock generator 2442′ according to an embodiment of the present invention. Referring to FIG. 8A, the digital spread spectrum clock generator 2442′ includes a reference clock generation unit 52′ and a control unit 82. The reference clock generation unit 52′ is configured to generate a reference clock signal CLK_ref with a fixed frequency. The control unit 82 is configured to perform frequency modulation on the reference clock signal CLK_ref to generate the spread spectrum clock signal CLK_SS. Thereafter, the driving signal generation circuit 2446 applies the driving signal DRV to the scan line selected by the selection module 2444 based on the spread spectrum clock signal CLK_SS, as illustrated in FIG. 4. Therefore, the driving signal DRV is a spread spectrum driving signal.

FIG. 8B is a waveform diagram of the spread spectrum driving signal DRV according to an embodiment of the present invention. Referring to FIG. 8B, the period of the modulated spread spectrum driving signal DRV increases from period T₁ to period T₁₀₀ by incrementing a ratio of the period of the modulated spread spectrum driving signal DRV to the reference clock signal CLK_ref and decreases from period T₁₀₀ to period T₁ by decrementing the ratio of period of the spread spectrum driving signal DRV to the reference clock signal CLK_ref. That is, the frequency of the modulated spread spectrum driving signal DRV is the reference clock signal CLK_ref increased by a factor or decreased by a factor. Since the reference clock signal CLK_ref has a fixed pulse width, the pulse width of the spread spectrum driving signal DRV after modulation is not a fixed value.

Referring to FIG. 4, the selection module 2444 selects a scan line of each scanning operation from the X-directional lines X₁ to X_{M} or the Y-directional lines Y₁ to Y_{N} according to a predetermined scanning sequence. The driving signal generation circuit 2446 applies the driving signal DRV to the scan line selected by the selection module 2444 during each scanning operation. Next, the ADC module 2448 receives voltages of a sense line selected during each scanning operation by the selection module 2444 and converts the voltages to digital signals. The signal processing unit 2450 performs calculation based on the digital signal converted each time by the ADC module 2448 to obtain the touch status of the touch-sensing panel 242.

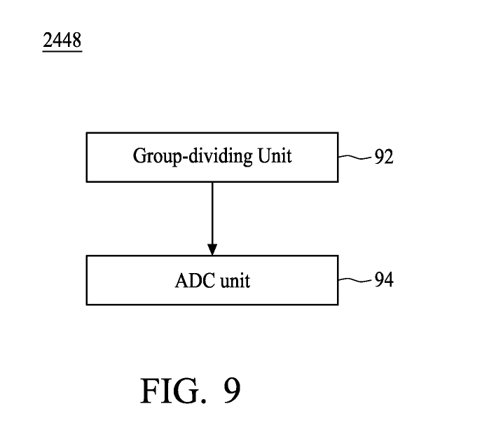

In order to further filter the noise interfered signal, in an embodiment according to the present invention, the ADC module 2448 further includes a group-dividing unit 92 as illustrated in FIG. 9. According to the present embodiment, the driving signal generating circuit 2446 consecutively applies the driving signal to the scan line selected by the selection module 2444. For example, the driving signal generation circuit 2446 consecutively applies the driving signal DRV five times to the scan line X₁. Therefore, the corresponding sense line Y₁ will generate five induced voltages 1.0V, 1.6V, 1.1V, 1.05V and 1.15V. The group-dividing unit 92 divides the induced voltages into multiple voltage intervals based on the largest and smallest values of the voltages. In the present embodiment, the induced voltages 1.0V, 1.1V, 1.05V, 1.15V reside in the first voltage interval from 1.0V to 1.2V, and the induced voltage 1.6V resides in the third voltage interval from 1.4V to 1.6V. Because the first voltage interval encompass the greatest number of induced voltage values, the ADC module 2448 converts an average voltage value of the first voltage interval from 1.0V to 1.2V to a digital signal, and the signal processing unit 2450 performs calculation based on the digital signal to obtain the touch status of the sense line Y₁.

In the present embodiment, the driving signal generation circuit 2446 and the ADC module 2448 operate based on the spread spectrum clock signal CLK_SS. Therefore, signals received by the signal processing unit 2450 are synchronized with the spread spectrum clock signal CLK_SS. In contrast, the touch-sensing panel module in the prior art configuration needs to be synchronized with the synchronization signal of the timing controller, such as the signal HSYNC, to avoid the operation period of the source driving circuit or the gate driving circuit. Therefore, an extra pin is required in the prior art configuration to receive the synchronization signal from the timing control circuit. In addition, the X-directional lines or Y-directional lines in the prior art touch-sensing panel are scanned and sensed according to a clock signal with a fixed frequency. As a result, energy of the signal in the prior art configuration will concentrate on a very narrow fundamental frequency band and the harmonics of the frequency band. Concentrating energy on the high frequency harmonics may easily cause radiation energy from electro-magnetic interference (EMI) to exceed the regulatory limits, such as the regulatory limits prescribed by the Federal Communications Commission (FCC) in the United States, the Japan Electronics and Information Technology Industries Association (JEITA) in Japan, and the International Electrotechnical Commission (IEC) in Europe.

The module of the present invention exploits the spread spectrum technique to perform modulation. The frequency of the clock signal, being frequency spread, is not fixed at a particular frequency, but varies within a predetermined frequency range. Therefore, the module of the present invention diversifies the energy of a particular frequency so that the signal has a lower energy distribution or a lower frequency range and therefore reduces the electro-magnetic interference.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A driving and sensing method applied in a touch-sensing input device, the touch-sensing input device comprising a touch-sensing panel module and a liquid crystal display panel module, the touch-sensing panel module comprising a touch-sensing panel and a control device, wherein the touch-sensing panel comprises a plurality of first-directional lines and a plurality of second-directional lines, and the first-directional lines and the second-directional lines are arranged intersecting one another, the method comprising the following steps:
generating a spread spectrum clock signal using the control device;
generating a driving signal and a sensing signal based on the spread spectrum clock signal;
outputting the driving signal to one of the first-directional lines or one of the second-directional lines;
receiving voltages on the corresponding second-directional line or first-directional line in response to the sensing signal and converting the same to a digital signal; and
determining a touch status of the touch-sensing panel based on the digital signal.

2. The driving and sensing method according to claim 1, wherein the step of generating the spread spectrum clock signal using the control device comprises:
generating a reference clock signal with a fixed frequency; and
performing frequency modulation on the reference clock signal to generate the spread spectrum clock signal, wherein a frequency of the spread spectrum clock signal varies periodically.

3. The driving and sensing method according to claim 2, wherein a pulse width of the spread spectrum clock signal is adjusted based on a control signal.

4. The driving and sensing method according to claim 2, wherein a frequency of the spread spectrum clock signal varies in the form of a triangular wave, a sine wave or a Hershey's Kiss wave between a largest frequency and a smallest frequency.

5. The driving and sensing method according to claim 1, wherein the LCD panel module operates based on a synchronization signal of a timing controller, and the spread spectrum clock signal is not synchronized with the synchronization signal.

6. The driving and sensing method according to claim 1, wherein the driving signal is output consecutively to one of the first-directional lines or the second-directional lines, the corresponding second-directional line or first-directional line generates M voltage values in response to the driving signal, and the converting step and the determining step comprise:
dividing a range of the M voltage values into N voltage intervals, wherein M and N are positive integers, and M>N;
selecting the voltage interval having the largest distribution of the M voltage values from the N voltage intervals;
converting a voltage value of the voltage interval to a digital signal; and
determining the touch status of the touch-sensing panel based on the digital signal.

7. A driving and sensing module applied in a touch-sensing input device, the touch-sensing input device comprising a touch-sensing panel module and a liquid crystal display panel module, the touch-sensing panel module comprising a touch-sensing panel and the driving and sensing module, wherein the touch-sensing panel comprises a plurality of first-directional lines and a plurality of second-directional lines, and the first-directional lines and the second-directional lines are arranged intersecting one another, the driving and sensing module comprising:
a spread spectrum clock generator, configured to generate a spread spectrum clock signal;
a selection module, configured to select a scan line and a sense line of each scanning operation from the first-directional lines and the second-directional lines;
a driving signal generation circuit, configured to generate a driving signal applied to the scan line selected during each scanning operation by the selection module based on the spread spectrum clock signal;
an analog to digital conversion module, configured to receive voltages on the sense line selected during each scanning operation by the selection module based on the spread spectrum clock signal, and further configured to convert the voltages to a digital signal; and
a signal processing unit, configured to calculate a touch status of the touch-sensing panel based on the digital signal output from the analog to digital conversion module.

8. The driving and sensing module according to claim 7, wherein the spread spectrum clock generator comprises:
a reference clock generation unit, configured to provide a reference clock signal with a fixed frequency;
a modulation unit, configured to provide a voltage control signal; and
a voltage-controlled delay unit, configured to perform frequency modulation on the reference clock signal based on the voltage control signal to provide the spread spectrum clock signal,
wherein a frequency of the spread spectrum clock signal varies periodically.

9. The driving and sensing module according to claim 8, wherein a pulse width of the spread spectrum clock signal is adjusted according to a control signal.

10. The driving and sensing module according to claim 8, wherein the voltage control signal is a triangular wave signal, a sine wave signal or a Hershey's Kiss signal.
